(19) United States
(12) Patent Application Publication
(10) Pub. No.: US 2005/0115351 A1
(43) Pub. Date: Jun. 2, 2005

(54) Seal structure for transfer robot

(75) Inventors: Kazuo Kimata, Bisai-shi (JP); Takao Nakamori, Bisai-shi (JP); Katsuhiko Kato, Bisai-shi (JP); Kiyonori Nakano, Bisai-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: AITEC CORPORATION, Bisai-shi (JP)

(21) Appl. No.: 10/843,361

(22) Filed: May 12, 2004

(30) Foreign Application Priority Data
Nov. 28, 2003 (JP) 2003-399441

(51) Int. Cl. B25J 17/00

(52) U.S. Cl. 74/490.01

(57) ABSTRACT

A seal structure is provided between an upper end portion (11a) of a main body housing (11) and an outer peripheral surface of an. arm driving shaft (13), an annular mechanical seal (51) which is pressure contacted with the outer peripheral surface of the arm driving shaft, an annular seal holding member (54) which holds the annular mechanical seal (51), and a floating action holding means (55) which is arranged between the upper end portion (11a) of the main body housing and the annular seal holding member (54), holds the annular seal holding member (54) so as to freely float and adjusts an attitude of the annular mechanical seal (51) in accordance with a tilting motion of the arm driving shaft (13).

### CROSS-REFERENCE TO RELATED APPLICATION

The present application claims priority to Japanese patent application No. 2003-399441 filed Nov. 28, 2003 is hereby incorporated into the present application by this reference.

### BACKGROUND OF THE INVENTION

(1) Field of the Invention

The present invention relates to a seal structure for a transfer robot for executing a transfer operation of a substrate such as a semiconductor wafer, a flat panel glass substrate and the like in a vacuum work chamber.

(2) Description of the Prior Art

The transfer robot for the vacuum work employs a seal structure for preventing the vacuum work chamber from being polluted, and there has been known as a conventional seal structure, a seal structure in which a sealing property is secured by a bellows with respect to a movement of an arm in a vertical direction (an elevating motion of the arm), and a sealing property is secured by a magnetic fluid seal with respect to a rotation of the arm (refer to, for example, Japanese Unexamined Patent Publication Nos. 2001-24045 and 2001-269890).

### SUMMARY OF THE INVENTION

However, an amount of stroke of the arm in the vertical direction is increased in recent years. In accordance with the increase of the stroke amount, the bellows is made large in size, and a high rigidity is required in the bellows. Further, a cost of the magnetic fluid seal is extremely high.

The present invention is made by paying attention to the problems in the conventional seal structure as mentioned above, and an object of the present invention is to provide a seal structure of a transfer robot which does not cause a large size of the seal structure even in the case that an amount of stroke of an arm is increased in a vertical direction, does not require a high rigidity, and can sufficiently secure a sealing property without using an expensive magnetic fluid seal.

In accordance with the present invention, there is provided a seal structure for a transfer robot which is provided with an arm protruding upward from a main body housing and makes the arm to execute an elevating motion, a rotating motion and a bending and stretching motion, wherein between an upper end portion of the main body housing and an outer peripheral surface of an arm driving shaft, there are provided an annular mechanical seal which is pressure contacted with the outer peripheral surface of the arm driving shaft, an annular seal holding member which holds the annular mechanical seal, and a floating action holding means which is provided between the upper end portion of the main body housing and the annular seal holding member, holds the annular seal holding member so as to freely float and adjusts an attitude of the annular mechanical seal in accordance with a tilting motion of the arm driving shaft.

In the seal structure for the transfer robot in accordance with the present invention, in a state in which the arm moves downward to a portion near the lowest end position and a heavy substrate is held by the leading end of the extended arm, the arm driving shaft is tilted by a weight of the substrate. When the arm driving shaft is tilted, the attitude of the inexpensive annular mechanical seal such as a lip seal or the like is adjusted in accordance with the tilting motion of the arm driving shaft on the basis of an operation of the floating action holding means. On the basis of the adjustment of the attitude of the annular mechanical seal, a pressure distribution which the annular mechanical seal is applied from the arm driving shaft becomes approximately uniform, and it is possible to secure a sealing property and a long service life of the annular mechanical seal. In this case, in the case that no floating action holding means is provided, the pressure distribution which the annular mechanical seal is applied from the arm driving shaft becomes uneven due to the tilting motion of the arm driving shaft, so that it is hard to secure the sealing property, and the annular mechanical seal tends to be deteriorated.

In accordance with the provision of the bellows for sealing between the annular seal holding member and the floating action holding means, it is possible to shut off a communication state between the vacuum work chamber and the main body housing inner portion caused by a gap between the annular seal holding member and the floating action holding means and generated by floating the annular seal holding member, by means of the bellows, so that it is possible to prevent the vacuum work chamber from being polluted. Further, since the bellows is arranged between the annular seal holding member and the floating action holding means, and is not expanded and contracted in accordance with the elevating motion of the arm, it is not necessary to make the bellows large in size even in the case that the stroke amount of the arm in the vertical direction is increased, and it is not necessary to increase the rigidity of the bellows.

Said arm driving shaft is an arm first driving shaft for rotating the arm.

### BRIEF DESCRIPTION OF THE DRAWING

FIG. 1 is a schematic view of a main portion of a transfer robot in accordance with an embodiment of the present invention.

### DESCRIPTION OF THE PREFERRED EMBODIMENTS

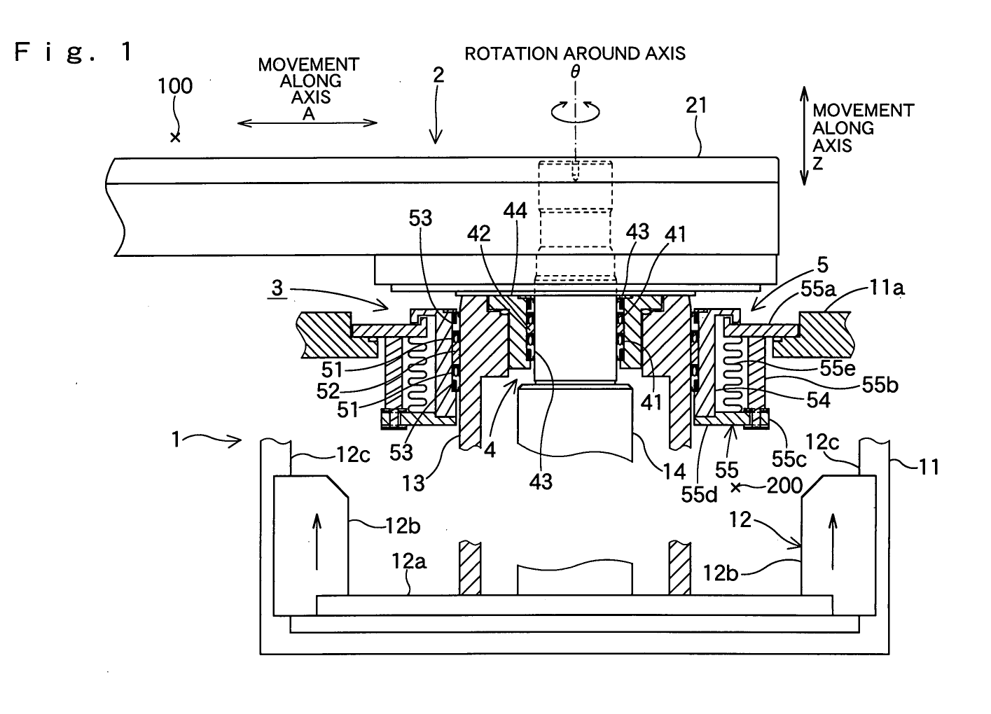

In FIG. 1, a transfer robot is structured by a main body portion 1 and an arm 2, and the arm 2 protrudes upward from a housing of the main body portion 1, that is, a main body housing 11, executes an elevating motion (a movement along an axis Z), a rotating motion (a rotation around an axis θ) and a bending and stretching motion (a movement along an axis A) within a vacuum work chamber 100 by an elevating mechanism 12, an arm first driving shaft 13 and an arm second driving shaft 14 arranged within the main body housing 11, and holds a substrate (not shown) such as a semiconductor wafer, a flat panel glass substrate in a leading end portion (not shown) so as to execute a transfer work.

The arm first driving shaft 13 is a driving shaft which connects between an actuator (not shown) and a case 21 of the arm 2, and rotates the arm 2, and the arm second driving shaft 14 is a driving shaft which connects between another actuator (not shown) and a pulley (not shown) within the case 21 of the arm 2, and bends and stretches the arm 2. The arm first driving shaft 13 and the arm second driving shaft 14 are arranged on the same axis, and are rotatable without interfering with each other.

The elevating mechanism 12 is provided with a plurality of members 12b which are mounted to an outer peripheral portion of a table 12a mounting the arm first driving shaft 13 and the arm second driving shaft 14 thereon, and a guide member 12c which is provided in an inner peripheral surface of the main body housing 11 and allows a linear movement in a vertical direction of each of the elevating members 12b while engaging with each of the elevating members 12b. The arm first driving shaft 13 and the arm second driving shaft 14 are moved upward and downward by elevating the elevating member 12b by the actuator (not shown), whereby the arm 2 is moved upward and downward.

The transfer robot is provided with a seal structure 3 for sealing between a vacuum work chamber 100 and a main body housing inner portion 200 in an atmospheric air side.

The seal structure 3 is provided in a side of an upper end portion 11a of the main body housing 11. The seal structure 3 is constituted by a first seal structure 4 for sealing between an inner peripheral surface of the arm first driving shaft 13 and an outer peripheral surface of the arm second driving shaft 14, and a second seal structure 5 for sealing between an outer peripheral surface of the arm first driving shaft 13 and the main body housing 11.

The first seal structure 4 is constituted by an annular mechanical seal 41 which is formed by an annular lip seal or the like which is pressure contacted with an outer peripheral surface of the arm second driving shaft 14, a grease 42 which is filled in the annular mechanical seal 41, an annular dust seal 43 which is arranged in an outer side of the annular mechanical seal 41 as occasion demands, and an annular seal holding member 44 which holds the annular mechanical seal 41 and the annular dust seal 43 in an inner recess portion in a press fitting manner.

The second seal structure 5 is constituted by an annular mechanical seal 51 which is formed by an annular lip seal or the like which is pressure contacted with an outer peripheral surface of the arm first driving shaft 13, a grease 52 which is filled in the annular mechanical seal 51, an annular dust seal 53 which is arranged in an outer side of the annular mechanical seal 51 as occasion demands, an annular seal holding member 54 which holds the annular mechanical seal 51 and the annular dust seal 53 in an inner recess portion in a press fitting manner, and a floating action holding means 55 which is provided between the main body housing upper end portion 11a and the annular seal holding member 54 and holds the annular seal holding member 54 so as to freely float.

The floating action holding means 55 is constituted by a hollow disc portion 55a which is fixed to an inner side of a top plate of the main body housing 11, a holding portion 55b which is fixed to the hollow disc portion 55a so as to extend annularly to a lower side, a direct acting bearing portion 55c which is arranged in a lower end of the holding portion 55b, a hollow disc portion 55d in which the outer side engages the direct acting bearing portion 55c and the inner side is fixed to a lower end of the annular seal holding member 54, and a bellows 55e which is arranged between the upper hollow disc portion 55a and the lower hollow disc portion 55d.

In the transfer robot structured in the manner mentioned above, in the case that the heavy substrate is held by the leading end of the extended arm 2 in a state in which the arm 2 moves downward to a state illustrated in FIG. 1, that is, to a position near the lowest end position, the arm first driving shaft 13 is tilted due to the weight of the substrate. When the arm first driving shaft 13 is tilted, the attitude of the annular mechanical seal 51 is adjusted in accordance with the tilting motion of the arm first driving shaft 13 on the basis of the operation of the floating action holding means 55. In other words, when the arm first driving shaft 13 is tilted, the hollow disc portion 55d is moved in a radial direction by the direct acting bearing portion 55c, so that the attitude of the annular mechanical seal 51 is adjusted. In accordance with the attitude adjustment of the annular mechanical seal 51, a pressure distribution which the annular mechanical seal 51 is applied from the arm first driving shaft 13 is approximately even, so that it is possible to secure a sealing property and achieve a long service life of the annular mechanical seal 51.

Further, since the bellows 55e shuts off a communication state between the vacuum work chamber 100 and the main body housing inner portion 200 caused by a gap between the annular seal holding member 54 and the floating action holding means 55 and generated by floating the annular seal holding member 54, it is possible to prevent the vacuum work chamber 100 from being polluted. Further, since the bellows 55e is arranged between the annular seal holding member 54 and the floating action holding means 55, and is not expanded and contracted in accordance with the elevating motion of the arm 2, the bellows 55e is not made large in size even in the case that the stroke amount of the arm 2 in the vertical direction is increased, and it is not necessary to increase the rigidity of the bellows 55e.

1. A seal structure for a transfer robot which is provided with an arm protruding upward from a main body housing and makes said arm to execute an elevating motion, a rotating motion and a bending and stretching motion, wherein between an upper end portion of said main body housing and an outer peripheral surface of an arm driving shaft, there are provided an annular mechanical seal which is pressure contacted with said outer peripheral surface of the arm driving shaft, an annular seal holding member which holds said annular mechanical seal, and a floating action holding means which is provided between said upper end portion of the main body housing and said annular seal holding member, holds said annular seal holding member so as to freely float and adjusts an attitude of said annular mechanical seal in accordance with a tilting motion of said arm driving shaft.

2. A seal structure for a transfer robot as claimed in claim 1, wherein the seal structure is provided with a bellows for sealing between said annular seal holding member and said floating action holding means.

3. A seal structure for a transfer robot as claimed in claim 1 or 2, wherein said arm driving shaft is an arm first driving shaft for rotating said arm.
